(19) United States
(12) Patent Application Publication
(10) Pub. No.: US 2005/0015271 A1
(43) Pub. Date: Jan. 20, 2005

(54) Service partner enablement unit in warranty management system

(76) Inventor: Supriya Iyer, Los Altos, CA (US)

Correspondence Address: KENYON & KENYON, 1500 K STREET, N.W., SUITE 700, WASHINGTON, DC, 20005, US

(21) Appl. No.: 10/860,009

(22) Filed: Jun. 4, 2004

Related U.S. Application Data
(60) Provisional application No. 60/486,893, filed on Jul. 15, 2003.

(51) Int. Cl. G06F 17/60

(52) U.S. Cl. 705/1; 705/9

(57) ABSTRACT

An automated service authorization system for use in a manufacturer or warrantor's computer system to validate and authorize requests for service. The system may respond to service requests by comparing repair request types to parameter data representing terms of either a warranty or a service agreement. If the repair request type matches the parameter data, the system may authorize and manage claims for service. The system may respond to entitlement lookup requests from service firms in a similar manner. Further, the system may provide service firms data regarding installed product bases for select customers, technical data regarding products to be repaired and parts availability data. Further, the system may include an analytic system to review claims data and determine financial viability of select service agreements or warranty policies.

### BACKGROUND

The present invention relates to automated services provided by a computer server to setup data about external service providers, maintain their performance information and manage warranty claims received from them.

Most modern firms typically rely on computer systems to manage their business processes. These business processes may manage sales and delivery of goods, purchases of supplies and other basic operations performed by the firm. As firm personnel interact with these processes, the firm's computer systems develop electronic records of firm operation which builds a base of data from which to model and analyze firm operations. However to have a highly cost efficient business model, many firms are outsourcing some service-related operations to third parties. Although the service operations may be outsourced to others, the outsourcing firm still must manage the operations to ensure they are being performed as designed. These firms have to ensure that the third parties are performing as expected while delivering the benefits of outsourcing. As a result they need a mechanism to track the external service provider performance. This is made possible by maintaining and automating their service level agreements and comparing them against the warranty service related transactional data.

The inventor perceives a need for an automated authorization system for use in a manufacturer or warrantor's computer system to validate and authorize requests for service. Such requests may fall under terms of a contract (service level agreement) in force between a product owner and the warrantor or it may fall under terms of a product warranty.

### BRIEF DESCRIPTION OF THE DRAWINGS

FIG. 1 is a block diagram of a computer system 100 according to an embodiment of the present invention.

FIG. 2 is a functional block diagram of a service partner enabling unit according to an embodiment of the present invention.

FIG. 3 is a data flow diagram illustrating various functions performed by a service partner enablement unit according to an embodiment of the present invention.

FIG. 4 is a simplified block diagram of a server.

### DETAILED DESCRIPTION

Embodiments of the present invention provide an automated authorization system for use in a manufacturer or warrantor's computer system to validate and authorize requests for service. The system may respond to service requests by authorizing and managing claims for service.

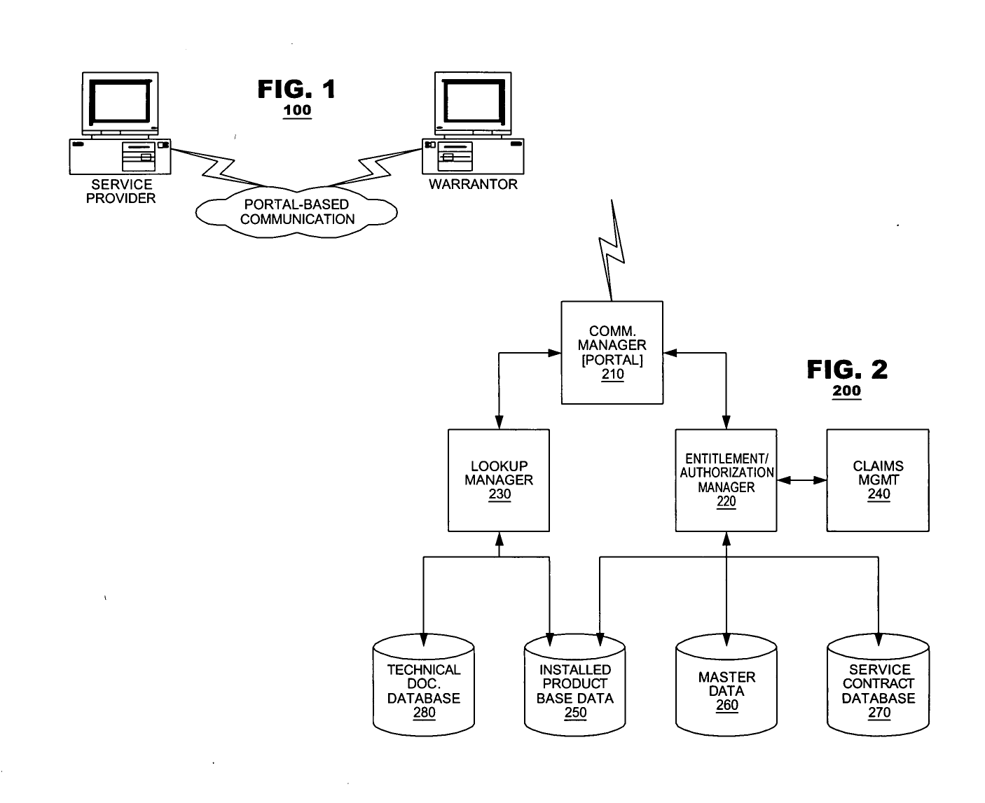

FIG. 1 illustrates a computer system 100 according to an embodiment of the present invention. The system 100 may include a first server 110 operating on behalf of a service provider and a second server 120 operating on behalf of a warrantor. The two servers 110, 120 may be provided in communication with each other via a computer network fabric 130. The servers open communication sessions with each other via portals or document exchange as described herein.

FIG. 2 is a functional block diagram of a service provider enablement (“SPE”) system 200 according to an embodiment of the present invention. As illustrated the SPE system 200 may include a communication manager 210, an entitlement/authorization manager (“EAM”) 220, a lookup manager 230 and a claims management system 240. The communication manager 210, as its name implies, manages portal-based communication services with servers from computer networks of various service providers. Alternatively, data exchange may occur through an electronic document exchange such as those facilitated by extensible markup language (“XML”). The communication manager 210 authenticates new requests received from service providers and manages the service providers' access to data structures within the SPE system 200. The communication manager may forward requests as appropriate to the EAM 220 or the lookup manager 230.

The EAM 220 responds to service requests and inquiries from service providers. It is supported by databases that store data regarding an installed base of products delivered throughout the marketplace (250), a database of master data 260 and a service contract database 270 that stores data representing parameters of various service contracts to which the warrantor is engaged. In response to service requests, the EAM 220 also may engage a claims management unit 240, which processes claims and engages other systems (not shown) to fulfill parts shipment and process financial reimbursement. Claims management systems are well-known. For example, SAP AG, the assignee of the present application currently includes claim management systems as part of its customer relations management (“CRM”) system and its R/3 system.

The lookup system 230 may respond to requests for information that do not require comparison against service contracts or warranty policies. The lookup system 230 may be supported by the installed product base database 250 and by a technical documentation database 280.

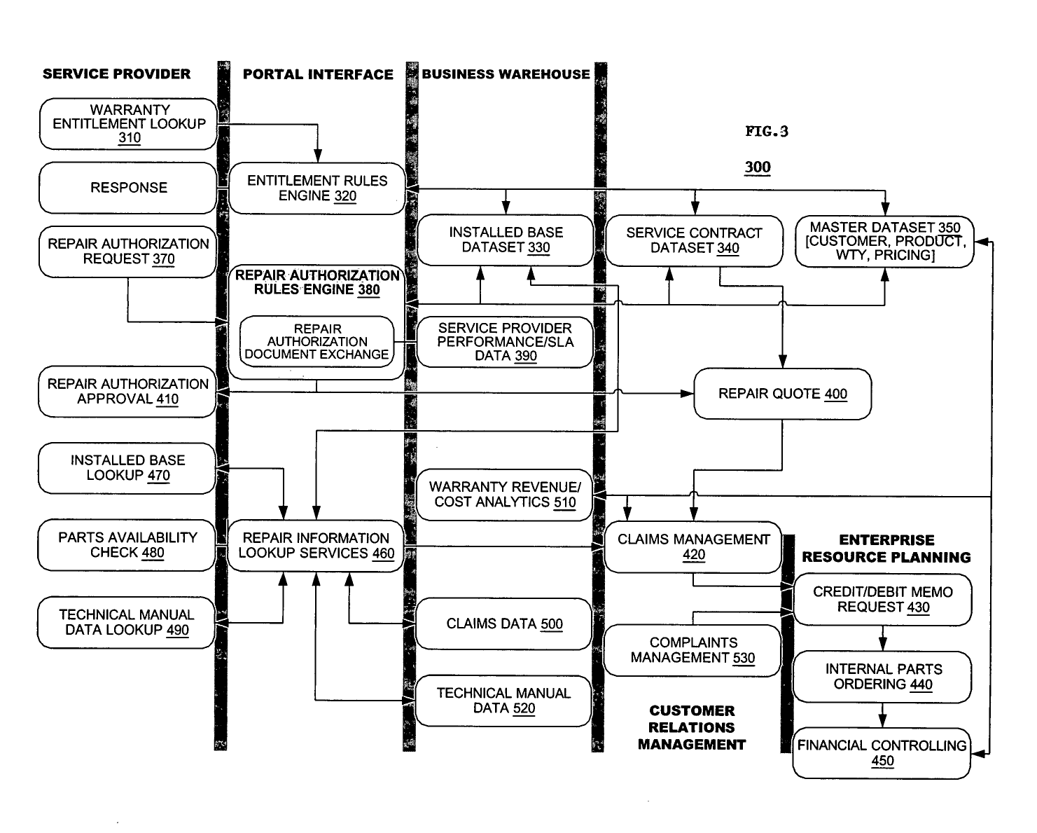

FIG. 3 is a data flow diagram 300 illustrating operations that may be performed by a SPE system during warranty entitlement checks or repair authorization. To determine whether an anticipated repair is covered by a warranty, a service provider may submit a warranty entitlement lookup request that includes a product identifier (typically a serial number or warranty policy number) and a repair identifier (box 310). The repair identifier may include a predetermined code that identifies the type of repair to be performed or a part number identifying a component being replaced or repaired.

Responsive to the entitlement lookup request, an entitlement rules engine authenticates the request and compares the repair identifier to parameter data representing a governing warranty. The entitlement rules engine 320 may refer the product identifier to an installed base dataset, which records information regarding products deployed in the marketplace (box 330). If the product identifier does not match any record present in the installed base dataset 330, the request will not be authenticated. If a match occurs, the installed base dataset 330 delivers a customer record identifying a warranty service contract under which the product is covered. Based on the customer record, the entitlement rules engine 320 may retrieve parameter data from a service contract dataset (box 340), from which the entitlement rules engine 320 may determine whether the identified service is covered under the service contract. Further, the entitlement rules engine 320 may retrieve warranty information from a master dataset (box 350), from which the entitlement rules engine 320 may determine whether the requested repair is covered by warranty or not. The entitlement rules engine evaluates the requested repair type against parameters of any service contract or warranty policy that governs over the product and generates a response (box 360) to the service provider, which indicates whether the requested repair may be performed within the scope of either a service contract or a warranty.

Before a repair may be performed, a service provider may submit a repair authorization request to the warrantor (box 370). As with the entitlement request, the authorization request may identify the product to be repaired and a repair to be performed. A repair authorization rules engine (box 380) may compare the product identifier to the installed base dataset (box 330) to authenticate the product. The repair authorization rules engine 380 also may interface with the service contract dataset 340 and master data 350 to retrieve service agreement and warranty parameter data and authenticate the request.

Additionally, the repair authorization rules engine 380 may refer to a service provider dataset 390 to authenticate the service provider from whom the authorization request is received. Warrantors may limit the scope of repairs that they authorize service providers to perform based upon the service providers' past performance, cost relative to other service providers, geographical locations and/or service response time. Service provider authentication 390 manages such functions.

If the repair authorization request is granted, the repair authorization rules engine 380 may cause a repair quote to be generated 400 and provided to the service provider's system in a repair approval response (box 410). The SPE system also may pass the repair quote 400 to a claims management system 420 therein. The claims management system 420 performs parts availability checks for the requested repair and provides a portal for the service provider to check on processing of the service claim (communication path not shown in FIG. 3). The service provider, for example, can check on delivery dates for shipped products and the like which may be necessary to complete repairs of the product.

The SPE system may include a credit/debit memo request system 430 that tracks billing and other financial aspects of recovery or payment that may be necessary by the warrantor. For example, if the warrantor is a retailer that sells other manufacturer's products under its own label, the warrantor may be entitled to recover from the manufacturer for warranty claims that indicate defective products. Similarly, if the SPE system manages affairs for a manufacturer but warranty claims are made to a retailer, the manufacturer may be required to reimburse the retailer for such claims. The credit/debit memo system may manage collection and reporting of such claims data.

The SPE system also may include an internal parts ordering system 440. The internal ordering system 440 may manage parts replenishments for inventory purposes. Often, warrantors establish policies require establishment and maintenance of a stockpile of product parts on an ongoing basis. When the warrantor ships a part to satisfy a repair request, for example, the internal parts ordering system 440 may order a replacement part to replenish its supplies. Stockpile levels may be established differently for different geographic regions and may vary based on observable product performance. Thus, the internal parts ordering system 440 maintains an ongoing inventory of products to satisfy anticipated repair claims.

The SPE system may include a financial controller 450 to capture costs associated with repair requests. The controller 450 may captures all costs including parts and labor, warranty costs collection, payouts and reimbursement. The financial controller also may manage funds for a warranty reserve fund, a pool of funds dedicated to payment of warranty claims.

The SPE system also may provide service provides access to information to assist them in scheduling and performing their repairs. The system may provide lookup services (box 460) to authorized service providers via its portal interface, which may permit service providers to survey an installed product base for its customers (box 470), to check on parts and their availability (box 480) and also to lookup technical information regarding products (box 490).

For example, in response to an installed base lookup request 470 that identifies a customer, the SPE system may survey its database of installed products 330 to identify products owned by a common customer. This may prove convenient for customers that own multiple deployed products. When a service provider is requested to perform maintenance on one piece of a customer's equipment, the service provider may determine whether the customer owns other similar products that should be serviced as part of a preventative maintenance effort.

In response to a request to check on parts availability, the lookup services module 460 may interface with the claims management system 420 to determine whether parts are available. The claims management system 420 may provide shipping information regarding a requested product and provide tracking information to permit the service provider to estimate a date on which parts will become available at its facilities.

In response to a request for technical information, the lookup services 460 may engage a technical documentation database 500 to retrieve and deliver product information to the service provider.

The SPE system also may include a warranty revenue/cost analytics module 510 to assess warranty programs in place and to determine whether the warranty program is a revenue generating program for the warrantor. The warranty module 510 is provided access to financial information representing revenues from sales of extended warranties and service plans and also representing costs associated with repair claims that fall under the service contracts. The analytics engine may analyze various repair requests by type and cluster them according to warranty/service agreement provisions to which the repairs relate. In this manner, the analytics engine may help to identify provisions of the warranty agreements or service agreements that are particularly costly or profitable to implement. Such information may become particularly useful for review by the warranty/service agreement policy makers within the warrantor's organization.

The SPE system may include a complaints management unit 520 to log customer complaints regarding service provided under a warranty agreement or service agreement.

The foregoing operations may be allocated across various systems of a warrantor's computer system. SAP AG, for example, currently sells various products such as a customer relations management system, a business warehouse system and an enterprise resource planning system. In an embodiment, functionality of the service enablement system 300 may be distributed across these systems as shown in FIG. 3.

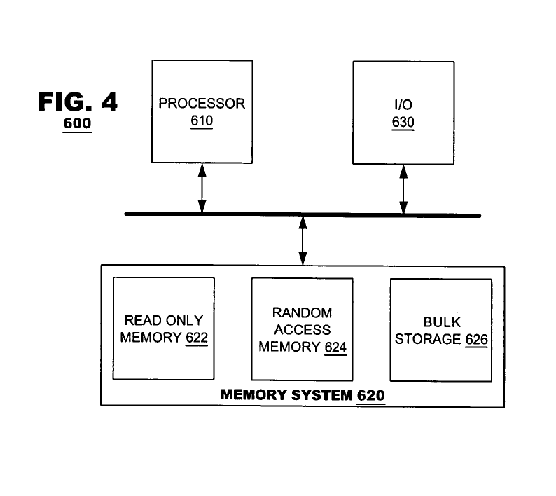

As noted, functionality of the foregoing embodiments may be provided on various computer platforms executing program instructions. One such platform 600 is illustrated in the simplified block diagram of FIG. 4. There, the platform 600 is shown as being populated by a processor 610, a memory system 620 and an input/output (I/O) unit 630. The processor 610 may be any of a plurality of conventional processing systems, including microprocessors, digital signal processors and field programmable logic arrays. In some applications, it may be advantageous to provide multiple processors (not shown) in the platform 600. The processor(s) 610 execute program instructions stored in the memory system. The memory system 620 may include any combination of conventional memory circuits, including electrical, magnetic or optical memory systems. As shown in FIG. 4, the memory system may include read only memories 622, random access memories 624 and bulk storage 626. The memory system not only stores the program instructions representing the various methods described herein but also can store the data items on which these methods operate. The I/O unit 630 would permit communication with external devices (not shown).

Several embodiments of the present invention are specifically illustrated and described herein. However, it will be appreciated that modifications and variations of the present invention are covered by the above teachings and within the purview of the appended claims without departing from the spirit and intended scope of the invention.

1. A service entitlement lookup method, comprising:
responsive to an entitlement lookup request, retrieving customer data from a database of installed products by a customer identifier,
based on the customer identifier, retrieving from storage a data record representing service plan parameters applicable to the customer,
comparing an identifier of a repair type against the service plan parameters, and
generating a response to the entitlement lookup request indicating whether the repair type is valid based on the service plan parameters.

2. The method of claim 1, wherein the entitlement lookup request is received via a communication portal.

3. The method of claim 1, wherein the entitlement lookup request is received via an XML document.

4. A warranty entitlement lookup method, comprising:
responsive to an entitlement lookup request received via a communication portal, retrieving customer data from a database of installed products by a customer identifier,
based on the customer identifier, retrieving from storage a data record representing warranty plan parameters applicable to the customer,
comparing an identifier of a repair type against the warranty plan parameters, and
generating a response to the entitlement lookup request indicating whether the repair type is valid based on the warranty plan parameters.

5. The method of claim 4, further comprising generating a repair quote for the identified repair.

6. The method of claim 5, further comprising submitting the repair quote to an automated claims management system.

7. The method of claim 4, further comprising comparing the entitlement lookup request against stored service provide performance data.

8. The method of claim 4, further comprising comparing the entitlement lookup request against stored service level agreements.

9. An automated repair authorization method, comprising:
responsive to an repair authorization request received via a communication portal, retrieving customer data from a database of installed products by a customer identifier,
based on the customer identifier, retrieving from storage a data record representing warranty plan parameters applicable to the customer,
comparing an identifier of a repair type against the warranty plan parameters, and
generating a repair quote if the repair type is valid based on the warranty plan parameters.

10. The method of claim 9, further comprising comparing an identifier of a service firm submitting the repair authorization request to a database of authorized service personnel and, validating the repair authorization request based on a match thereto.

11. The method of claim 9, further comprising engaging a claims management system.

12. The method of claim 9, further comprising initiating a parts delivery process within an automated system and initiating ordering of a replacement part to maintain a stockpile of parts at a predetermined level.

13. An automated repair authorization method, comprising:
responsive to an installed product base lookup request received via a communication portal, authenticating a service firm that initiated the request,
if the service firm passes authentication, retrieving a customer record from an installed product database,
generating a request response that identifies to the service firm all products in the customer record.

14. A warranty management system, comprising:
a communication manager,
a first database representing a base of installed products, records therein including an customer identifier,
a second database storing data records representing warranty plan parameters applicable to customers,
an entitlement manager, responsive to an entitlement lookup request received from the communication portal, to
retrieve customer data from the first database,
based on the customer identifier, retrieve warranty plan parameters from the second database,
compare an identifier of a repair type against the warranty plan parameters, and
generate a response to the entitlement lookup request indicating whether the repair type is valid based on the warranty plan parameters.

15. The system of claim 14, wherein the entitlement manager further generates a repair quote for the identified repair.

16. The system of claim 15, further comprising a claims management system to receive the repair quote.

17. The system of claim 14, wherein entitlement manager compares the lookup request against stored service provide performance data.

18. The system of claim 14, wherein entitlement manager compares the lookup request against stored service level agreements.

19. Computer readable medium storing program instructions thereon that, when executed, cause an executing device to:
retrieve customer data from a database of installed products by a customer identifier, responsive to an entitlement lookup request received via a communication portal,
based on the customer identifier, retrieve from storage a data record representing warranty plan parameters applicable to the customer,
compare an identifier of a repair type against the warranty plan parameters, and
generate a response to the entitlement lookup request indicating whether the repair type is valid based on the warranty plan parameters.

20. The medium of claim 19, wherein the program instructions further cause the device to generate a repair quote for the identified repair.

21. The medium of claim 20, wherein the program instructions further cause the device to submit the repair quote to an automated claims management system.

22. The medium of claim 19, wherein the program instructions further cause the device to compare the entitlement lookup request against stored service provide performance data.

23. The medium of claim 19, wherein the program instructions further cause the device to compare the entitlement lookup request against stored service level agreements.
